(19) United States
(12) Patent Application Publication
(10) Pub. No.: US 2014/0318999 A1
(43) Pub. Date: Oct. 30, 2014

(54) Packaging and Methods for Displaying Tools

(71) Applicant: Shining Golden Yida Welding & Cutting Machinery Manufacture, Ltd., Hong Kong (HK)

(72) Inventor: Davey Z. Liang, Rancho Santa Fe, CA (US)

(73) Assignee: Shining Golden Yida Welding & Cutting Machinery Manufacture, Ltd., Hong Kong (HK)

(21) Appl. No.: 14/260,050

(22) Filed: Apr. 23, 2014

Related U.S. Application Data
(60) Provisional application No. 61/815,711, filed on Apr. 24, 2013.

(51) Int. Cl. B65D 5/00; B31B 1/20; B65D 5/02; B31B 1/26

(52) U.S. Cl. CPC B65D 5/0095; B31B 1/26; B31B 1/20; B65D 5/02; B31B 2201/147; B31B 2201/26
USPC 206/349; 493/56

(57) ABSTRACT

A package made of a single piece of cardboard, with at least one aperture, which encases, displays and prevents damage to a tool. The cardboard has a front portion, a back portion, a top portion, a bottom portion and two side portions. The top portion is formed by parallel creases between the front and back portions which, when folded, create a rectangular top portion. Insertion of a tab into a slit forms the bottom portion which serves as a horizontal ledge so the entire packaged tool stands upright. The aperture in the package permits a tool's grip to protrude from the package. The one piece cardboard construction with aperture may further enclose a clam or blister package which encloses any non-grip portion of a tool. Tool accessories may be placed and stored within the package. Additional apertures permit hanging onto a projection. Other embodiments are described and claimed.

### CROSS-REFERENCE TO RELATED APPLICATION

This application claims the benefit of the filing date of U.S. provisional patent application No. 61/815,711, incorporated herein by reference, which was filed on Apr. 24, 2013, by the same inventor of this application.

### BACKGROUND OF THE PRESENT DISCLOSURE

1. Technical Field

The present disclosure relates in general to packaging and related methods for packaging. More particularly, but not by way of limitation, this disclosure pertains to a type of packaging for power tools with grips, particularly at point of sale displays. Various methods of manufacturing, designs, features, and aspects thereof of such packaging are disclosed and elucidated.

2. Description of Related Art

Blister packages and clam packages are two types of packaging. Blister packages customarily are used to mount small items of hardware, stationary and other goods on a display card under a blister covering. The blister covering is typically made of transparent, stiff, but flexible material such as polyvinyl chloride (PVC) and applied to the display card by heat and pressure-adhesive techniques. A clam package utilizes two pieces with surfaces shaped in the form of the product which is held by the package. The two surfaces of the clam package generally are snapped or otherwise held together by mechanical or adhesive means. The two pieces may be manufactured so the surfaces include integral snap-over edges or snap-together elements for resilient engagement. Further still, a clam package may be manufactured using a clasp made from a peg and a hole which securely fasten the two surfaces together.

Blister packages and clam packages generally encompass the entire product, protecting the product from damage. However, for products which are meant to be hand-held e.g., feature grip portions, such packages may hinder the ability of a customer to touch and feel at least a portion of the encased product.

What is needed then are packages for displaying hand tools with grips, particularly at point of sale displays. More specifically, there is a need for packages which house hand tools in a manner allowing them to be manipulated while in the package so the customer may experience the feel of the handle or grip and operation of the tool without opening the display package.

### SUMMARY OF THE EMBODIMENTS

This disclosure relates generally to paper-based packages with, optionally, a clam package portion encasing specific regions of a tool with a grip or handle. Packages according to this disclosure may have features accommodating display on a shelf, specifically either by hanging means or standing upright (e.g., placed on its bottom portion or another flat portion of a substantially three-dimensional structure of the package). Alternatively, the paper-based package may include a blister package portion encasing specific regions of a tool with a grip or handle. In another variant, the entire package may be made of one piece construction of cardboard or plastic.

According to a first aspect of at least one disclosed embodiment, there is provided a single piece of cardboard which encases a tool and has at least one aperture. Of course, multiple pieces of cardboard could be used to form a similar package utilizing a connection means between the multiple pieces. The package has a front portion, a back portion, a top portion, a bottom portion and two side portions connected to their adjoining portion via a fold in the cardboard or via a slit and tab mechanism. The tabs may be configured to be inserted into a respective slit of an adjoining portion to form a connection between two adjoining portions. The top portion is formed by parallel creases between the front and back portions which when folded, create a rectangular top portion. At least one tab and at least one slit are positioned complementary to one another on the front and side portion so that the tab may be inserted into the slit.

Insertion of a tab into a slit forms the bottom portion of a cardboard package around the tool and may help to prevent tool damage. The bottom portion may serve as a horizontal ledge so the entire packaged tool may stand upright on a shelf without need for additional upright support.

According to a second aspect of at least one disclosed embodiment, the aperture in the package permits a tool's grip to protrude from the package. Thus, a user may touch, feel and weigh the exact tool that they are contemplating purchasing.

According to a third aspect of at least one disclosed embodiment, the one piece cardboard construction with aperture may further enclose a clam package which in turn encloses any non-grip portion of a tool. A user may thereby view almost all aspects of the tool they are contemplating purchasing. Additionally, tool accessories may be placed and stored within the clam package.

According to a fourth aspect of at least one disclosed embodiment, the front or rear portions may contain additional apertures permitting hanging of the packaged tool on a hook, nail or other projection. Thus, a row of packaged tools, placed front to back, may be displayed along a wall.

According to other aspects of the disclosed embodiments, methods of manufacturing the packaging for the tool and methods of using the tool in the package are provided.

### BRIEF DESCRIPTION OF THE DRAWINGS

The following figures form part of the present specification and are included to further demonstrate certain aspects of the present claimed subject matter, and should not be used to limit or define the present claimed subject matter. The present claimed subject matter may be better understood by reference to one or more of these drawings in combination with the description of embodiments presented herein. Consequently, a more complete understanding of the present embodiments and further features and advantages thereof may be acquired by referring to the following description taken in conjunction with the accompanying drawings, in which like reference numerals may identify like elements, wherein:

FIGS. 1A-B illustrate a diagram showing a plan view of the front of a package created in accordance with one or more embodiments of the present disclosure;

FIG. 2 illustrates an elevational view of the top portion of the package of FIG. 1;

FIG. 3 illustrates an elevational view of the back portion of the package of FIG. 1;

FIG. 4 illustrates an elevational view of the left side of the package of FIG. 1;

FIG. 5 illustrates a diagram of a plan view of a bottom of the package of FIG. 1;

FIG. 6 illustrates an elevational view of a front and a top portion of the package of FIG. 1;

FIG. 7 illustrates an elevational view of the right side of the package of FIG. 1;

FIG. 8 illustrates an elevational view of a left and top portion of the package of FIG. 1;

FIG. 9 illustrates a plan view, showing a clam package encompassing the non-grip portion of a tool, in accordance with further alternative embodiments of the present disclosure; and,

FIG. 10 illustrates a plan view, showing an outer laminate region of a blister package which may be used to encompass the non-grip portion of a tool, in accordance with further alternative embodiments of the present disclosure;

FIG. 11 illustrates a plan view of the exterior of a one piece cardboard template, in accordance with further alternative embodiments of the present disclosure;

FIG. 12 illustrates a plan view of the interior of the one piece cardboard template of FIG. 10.

### DETAILED DESCRIPTION OF ONE OR MORE EMBODIMENTS

The foregoing description of the figures is provided for the convenience of the reader. It should be understood, however, that the embodiments are not limited to the precise arrangements and configurations shown in the figures. Also, the figures are not necessarily drawn to scale, and certain features may be shown exaggerated in scale or in generalized or schematic form, in the interest of clarity and conciseness.

While various embodiments are described herein, it should be appreciated that the disclosed embodiments encompass many inventive concepts that may be embodied in a wide variety of contexts. The following detailed description of example embodiments, read in conjunction with the accompanying drawings, is merely illustrative and is not to be taken as limiting the scope of the invention, as it would be impossible or impractical to include all of the possible embodiments and contexts in this disclosure. Upon reading this disclosure, many alternative embodiments will be apparent to persons of ordinary skill in the art. The scope of the invention is defined by the appended claims and equivalents thereof.

Illustrative embodiments of this disclosure are described below. In the interest of clarity, not all features of an actual implementation are described in this specification. In the development of any such actual embodiment, numerous implementation-specific decisions must be made to achieve the design-specific goals, which will vary from one implementation to another. It will be appreciated that such a development effort, while possibly complex and time-consuming, would nevertheless be a routine undertaking for persons of ordinary skill in the art having the benefit of this disclosure.

With regard to terminology, the use of the term “preferable” or “preferably” is to be understood as indicating, inter alia, that the stated matter need not be as stated and that alternatives and contraries to the stated matter may be obtained, unless indicated otherwise. For example, if it were stated that a widget preferably has a certain characteristic (e.g., a component is preferably inclined at a certain angle, or two components preferably correspond in a certain manner, etc), it is thereby indicated that the widget may also not have the certain characteristic, may have a different or contrary characteristic, etc., unless indicated otherwise. In this regard, it may be the case that, within a given embodiment, an element may not be able to have a contrary characteristic, but that in a different embodiment, the element may have the contrary characteristic. Nonetheless, unless indicated otherwise, different embodiments are combinable with one another (combinations of more than two embodiments being possible), and any number of features of different embodiments are combinable with one another.

The structure, manufacture and operation of packages according to some embodiments will be described with reference to the figures.

One advantage of the disclosed packaging technique is that a tool packaged in accordance with the disclosed techniques may be free standing on its bottom portion and not require additional hardware (e.g., shelves, hooks, other boxes) to display at a point of sale location such as a store. The package according to some embodiments may be substantially three-dimensional to accommodate standing freely on its bottom and the material of the package may have sufficient structural integrity to fully support the weight of its contents when oriented in this manner. To fully appreciate the disclosed embodiments, the packaging built in conformance with this disclosure should not be obscured by additional coverage when displayed at the point of sale location. In some embodiments, printed colors and brands are placed on the exterior of the package. This may reduce waste and unneeded packaging while maximizing a potential user's ability to fully appreciate all aspects of a tool he/she is contemplating purchasing.

Designs in accordance with this disclosure may permit a seller to hang a tool, as well as stand the tool upright so that it is easily visible to a customer. The present embodiments may allow customers to see and feel the product, unlike other packaged products that either allows them to see the product partially or to see the product completely but not let them touch it. Packages in accordance with this disclosure allow a user to feel the important parts, like the grip, and get a sense of tool weight and balance. The user may be prevented from being able to touch some portion of the tool like the body. This may be a very important feature for a retail seller as seeing items in person is a main advantage of a brick-and-mortar store over the Internet. With the Internet, one views the product one-dimensionally, whereas at a brick-and-mortar store, a potential purchaser of the product may both see and feel the product.

The disclosed packaging techniques may allow a retailer to hang a tool on a peg hook or alternatively stand the enclosed tool on its own. Frequently, prior art methods of packaging tools and tool products include packaging the product in clear clam shells or clam packaging that encompass the entire tool. These complete clam shells only allow retailers to hang the product on a wall, the tool packaged in a complete clam shell cannot stand on its own. If it is not hanging, the tool package may only lie flat. If the product is laying flat the customer will not be able to see it from a distance. The customer may have to walk closer and pick it up to see it. The presently disclosed embodiment allows the retailers to hang this type of product on the wall or stand it up in its own packaging.

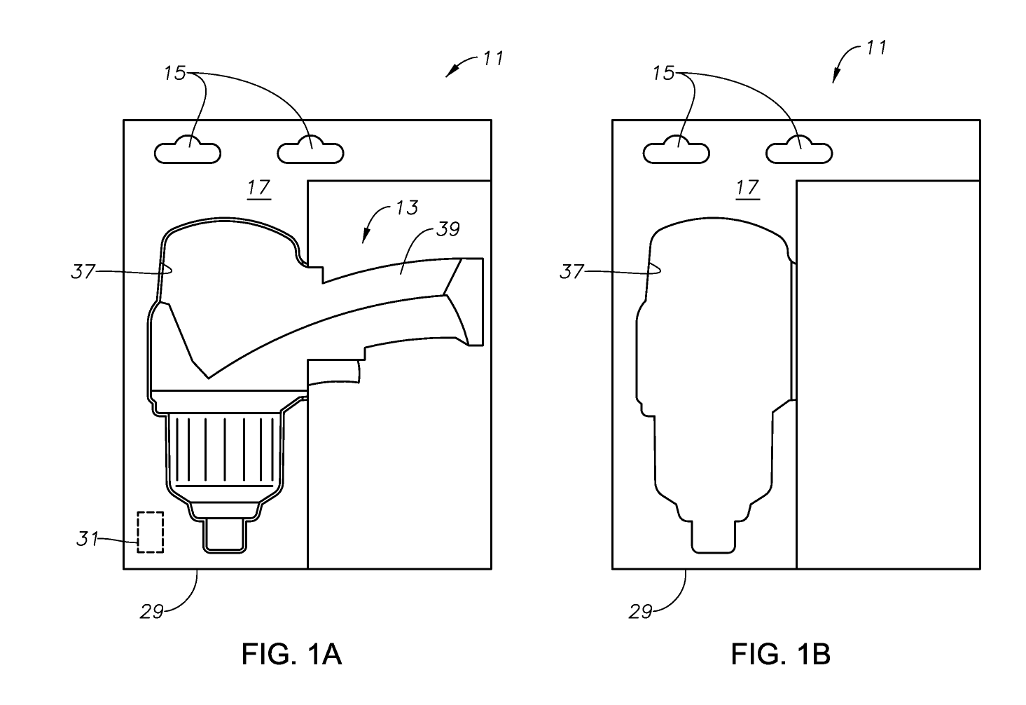

FIG. 1A illustrates a plan view of the front 17 of a package 11 and tool 13 with grip 39 inside tool aperture 37 according to one or more disclosed embodiments. In some cases, grip 39 may include a trigger and one or more configuration switches (e.g., forward/reverse or variable speed) not shown. FIG. 1B illustrates a plan view of package 11 without tool 13. As shown in FIG. 1A, one or more apertures 15 may be cut from the package so that retailers may hang the enclosed tool, for example, on adjustable peg hooks. The number of holes required to hang the package is variables and may be as few as one. Thus, different embodiments may have differing numbers, spacing and placement of apertures 15 used for hanging. In yet another embodiment, the implementation of the hanging function may also vary. There may be an aperture 15 on the package or the hanging aperture 15 may eliminated altogether. Instead, a clear plastic piece or plurality of pieces (not shown) which have an aperture to function as aperture 15 and an attachment means may be stuck onto the box. These plastic pieces (or pieces made of a material other than plastic) with at least one aperture in them may be used to hang the enclosed product.

The package 11 according to one or more disclosed embodiments may allow an encompassed tool 13 to stand on its own (e.g., on bottom 29). For instance, a seller may wish to run a promotion on a side stack. A side stack may be a free standing display where a batch of 6 or 12 units of the product may be placed in the aisle, or on a table, where there is not necessarily a place or means to hang the enclosed product. Or sometimes the store is small, and the seller is running out of space, and although they do not have space for it on a wall, the seller may have space on the shelves. Thus, the seller has the flexibility to either hang the enclosed tool on the wall or to allow it to stand. Letting the product stand permits product placement practically anywhere in the store. Also, in certain embodiments the tool's orientation at display time may be important. For example, a tool such as a drill may be oriented as much as possible in the orientation for actually gripping the grip portion of the drill. That is, the portion with the grip 39 may be positioned along the horizontal and run along the same axis as top 43 of package 11.

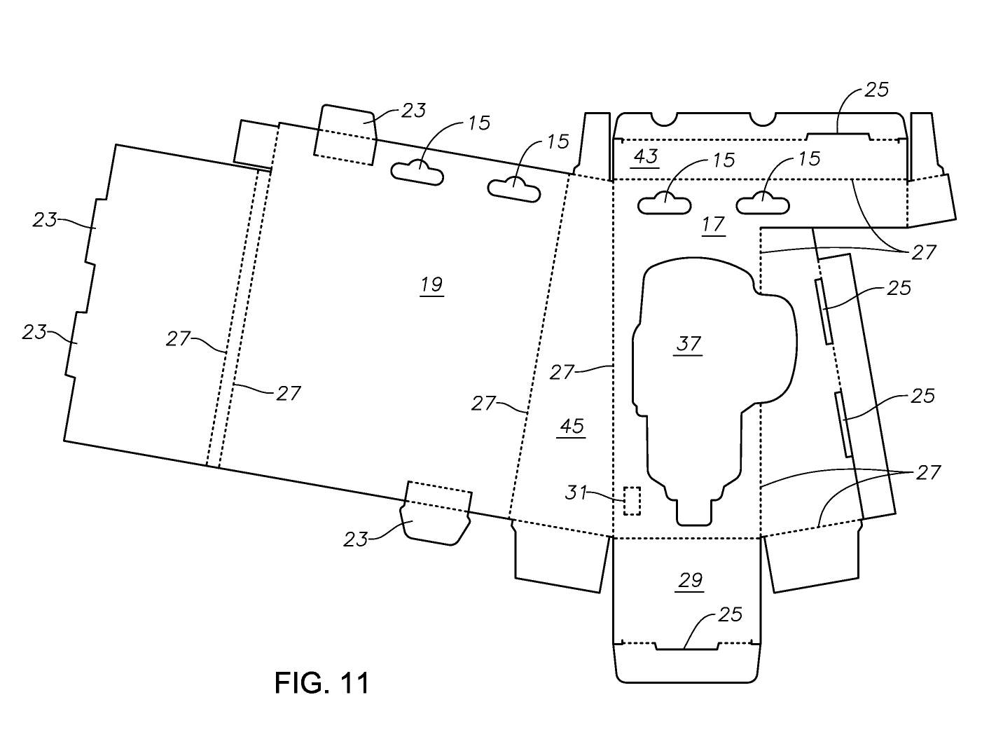

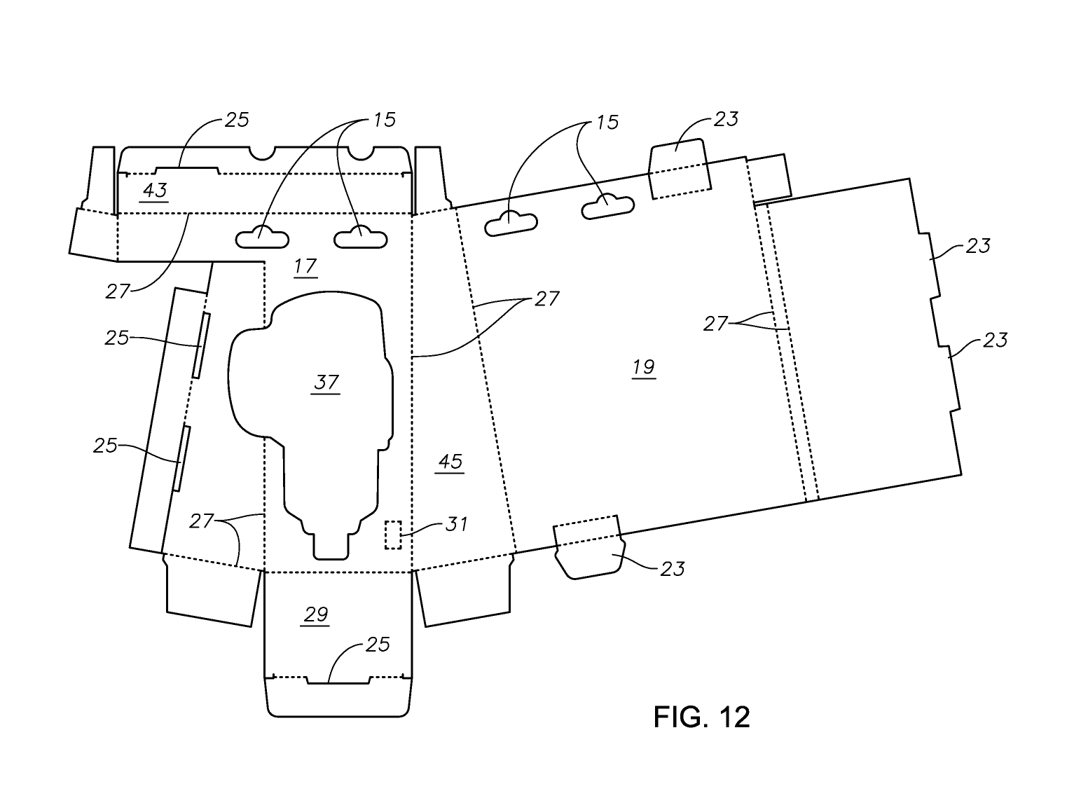

Another aspect of the disclosed packaging design is that it may serve as a theft deterrent. Protecting against the threat of having the enclosed product stolen may be just as important as advertising the product. In order to fully access the enclosed tool, a user will have to rip apart the package. When bought, customers will likely have to take the product home and use something to cut it open. They can't easily open it without external tools such as box cutters or scissors. In some embodiments, an anti-theft device 31 is attached to the paper-based portion of the package prior to insertion of any tabs into any slits. As shown in FIGS. 11 and 12, the series of tabs 23 and slits 25, alone or in combination with an anti-theft device 31, may make it difficult to access the enclosed tool and reduce the likelihood of theft of the enclosed product.

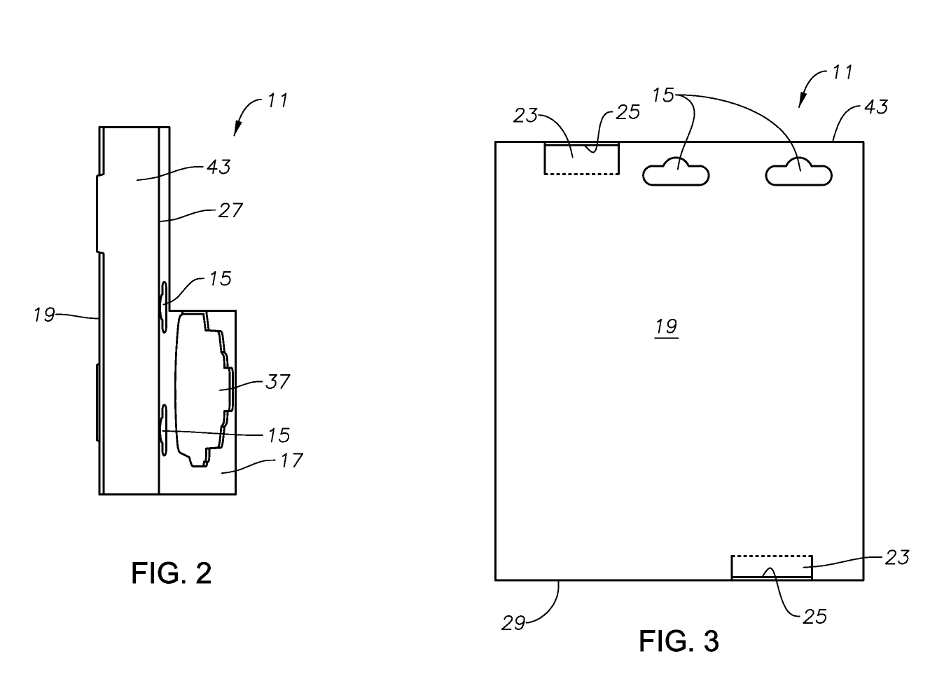

FIG. 2 illustrates an elevational view of the top 43 of package 11. In this view, creases 27 illustrate where the cardboard packaging may be folded to create the overall package from a cardboard pattern. Creases 27 are illustrated as dotted lines in FIGS. 11 and 12, however not all dotted lines are numbered so as not to obscure the figures. As stated above, like elements from FIG. 1 (e.g., tool aperture 37 and front 17) retain the same element numbers in subsequent figures.

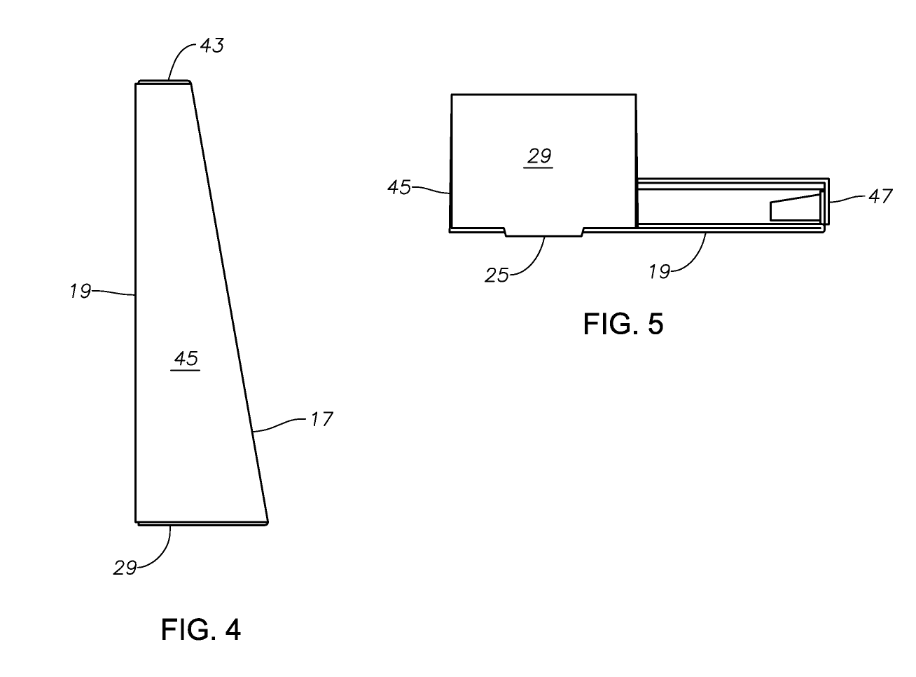

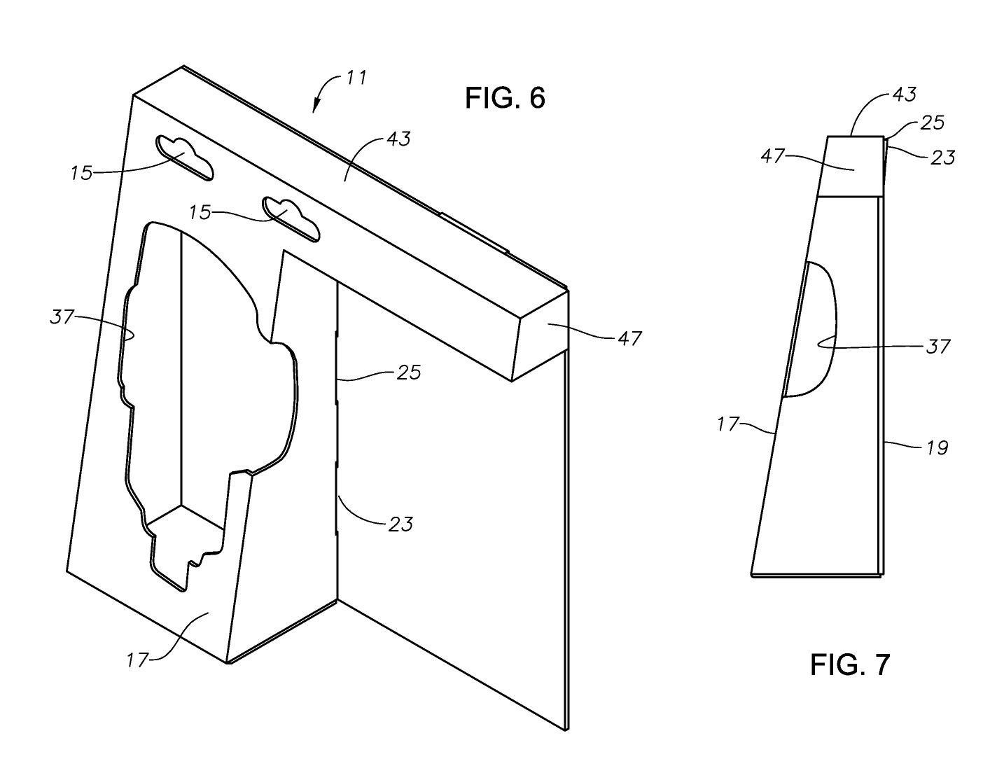

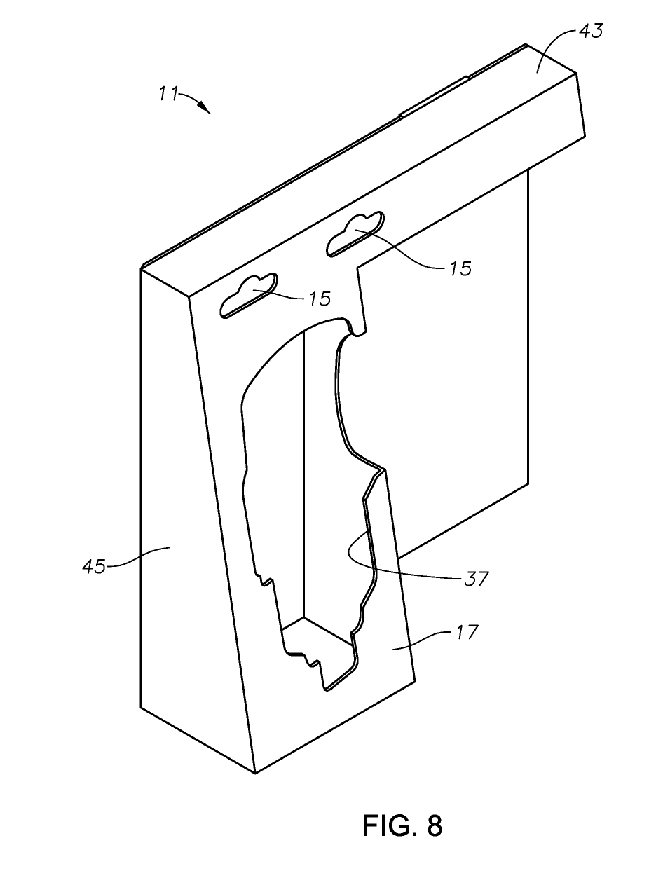

FIG. 3 illustrates an elevational view of the rear 19 of package 11. Note that tabs 23 are illustrated as inserted into slits 25. FIG. 4 illustrates a left side 45 of package 11. FIG. 5 shows the rectangular horizontal ledge bottom 29 which provides the surface on which package 11 is able to stand upright for display on a shelf. Insertion of a tab in the rear portion 19 of the package 11 into a slit 25 along with a crease forms the bottom portion of a cardboard package around the tool and may help to prevent tool damage. FIG. 5 also illustrates right side 47 of package 11 as seen from the bottom. FIGS. 6-8 illustrate other perspective views of package 11 and maintain consistent reference numbers with other figures.

Air tools are perceived as quite heavy tools. They are much heavier than a normal power tool or a hammer or screw driver. Also they are usually an odd shape, meaning they cannot stand on their own. The present disclosure provides solutions to these and other challenges. As shown in FIG. 5, the rectangular horizontal ledge may accommodate standing the package vertically on a shelf and is sufficient to support the weight of the package and tool.

The present packaging embodiment may also obviate the need for a display model, reducing costs for sellers. Sellers may have the flexibility to hang or stand enclosed products, and also to allow the customers to feel and touch at least a portion of the products without having to insert their hand inside the packaging. With a display model, the potential purchaser may feel and touch a similar, but not identical product to the one they wish to purchase. Purchasers are unable to buy the exact product they have seen, touched and felt, and instead must buy an item that is in a box. A product sold in a box that is fully closed cannot responsibly be opened prior to purchase. A buyer cannot touch the actual product he is going to use until he buys it, takes it home, and opens it. In accordance with the disclosed packaging embodiments, the buyer may feel and examine the exact product he/she is purchasing. As shown in FIG. 1, the entire product enclosed in the packaging, may be visible to a potential purchaser. When the purchaser sees the product, feels the product, and does not like it, they do not have to buy the product. This may reduce the likelihood of return of products packaged according to the presently disclosed embodiments.

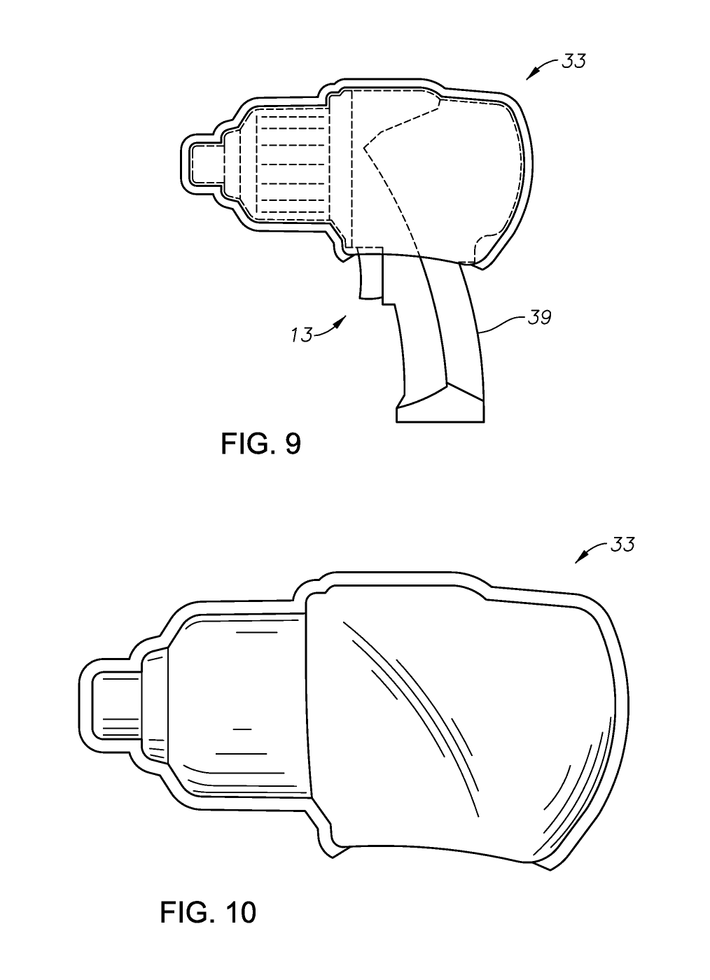

In another alternative embodiment, the packaging described in this disclosure facilitates the display of optional accessories that may be attached to a tool. As shown in FIGS. 9 and 10, a clam package or blister package portion may be provided, including an optional plastic piece 33 that covers the body or non-grip region of the tool. If accessories are included with the tool (e.g., optional attachments such as drill bits), they may be located within the clam shell or the blister package 33. Optionally, if there are other accessories, the clam shell portion 33 may be extended to cover the accessory piece, so the accessory may be on the side or next to the product. Thus, the user may be able to view any included accessories. While the user is not able to touch or feel such accessories, the seller's interests are protected, as accessories that may be easily stolen or misplaced are attached securely to tool packaging.

In accordance with some embodiments of this disclosure, the packaging disclosed is preferably paper-based in certain portions using paper stock such as cardboard. As shown in FIGS. 11 and 12, the cardboard package may be a one-piece construction based on a template cutting dye that perforates a larger stock piece of cardboard. The cardboard template may include at least one aperture 37 to accommodate placement of the tool. Furthermore, the aperture 37 may accommodate customer access to the grip portion of the enclosed tool as shown in FIG. 1. In building the packaging, the cardboard may contain a plurality of creases 27 which facilitate folding to create the ledges and supporting structures of the assembled package. The cardboard template may also contain a plurality of slits 25 and tabs 23 which may be used to form a complete package to further seal and insulate the enclosed tool.

The embodiment shown relative to package 11 is for an impact wrench. However, any power or hand tool may be encompassed by the disclosed packaging techniques with the primary required alteration being the configuration of the aperture.

In another embodiment of the packaging, the clam shell 33 may wrap and protect the non-grip portion of a tool. The clam package 33 may be made of a clear or transparent plastic-based material, for example. Attachment of the clam package 33 to the cardboard package 11 may require an additional attachment means, for example the use of additional tabs or grooves, or adherence means such as glue.

To further deter theft an implementation of the disclosed techniques may include gluing the clam shell 33 to the cardboard portion of package 11. In this configuration, if someone were to try and steal the enclosed tool by opening it at the store, they would have to get past the box and then they would still have to rip the paper/cardboard and then the clam shell 33. In an embodiment with a blister package portion, the plastic-based blister portion may be glued or stuck to the box, so a potential thief cannot easily separate the blister from the paper-based backing without risk of detection. The package 11 may be large and optionally may contain a source tag or other anti-theft device 31 as shown in FIG. 1A.

In light of the principles and example embodiments described and illustrated herein, it will be recognized that the example embodiments may be modified in arrangement and detail without departing from such principles. Also, the foregoing discussion has focused on particular embodiments, but other configurations are contemplated. In particular, even though expressions such as “in one embodiment,” “in another embodiment,” or the like are used herein, these phrases are meant to generally reference embodiment possibilities, and are not intended to limit the invention to particular embodiment configurations. As used herein, these terms may reference the same or different embodiments that are combinable into other embodiments.

This disclosure may include descriptions of various benefits and advantages that may be provided by various embodiments. One, some, all, or different benefits or advantages may be provided by different embodiments.

In view of the wide variety of useful permutations that may be readily derived from the example embodiments described herein, this detailed description is intended to be illustrative only, and should not be taken as limiting the scope of the invention.

What is claimed is:

1. A package for displaying a tool, the tool comprising a grip portion and a non-grip portion, the package comprising:
a bottom portion;
a front portion connected to the bottom portion;
a rear portion connected to the bottom portion and to the front portion, the rear portion being configured to cover a rear-facing surface of the grip portion; and
a first aperture provided in the front portion for permitting the grip portion to be gripped, wherein the front portion, the rear portion and the bottom portion form a substantially three-dimensional structure.

2. The package of claim 1, further comprising:
one or more slits provided in at least one of the front portion, the rear portion, and the bottom portion; and
one or more tabs provided in at least one of the front portion, the rear portion, and the bottom portion, the one or more tabs configured for insertion into respective ones of the one or more slits.

3. The package of claim 1, further comprising:
a transparent portion covering a portion of the aperture and permitting at least a portion of the non-grip portion to be viewed through the transparent portion.

4. The package of claim 3, wherein at least one of the front portion, the rear portion, and the bottom portion comprises cardboard and wherein the transparent portion is attached to the cardboard portion using an adhesive means.

5. The package of claim 3, wherein the transparent portion comprises a clam shell covering.

6. The package of claim 1, wherein at least one of the front portion, the rear portion, and the bottom portion comprises cardboard.

7. The package of claim 1, wherein the front portion, the rear portion, and the bottom portion together comprise a single piece of material, and each of the front portion, the rear portion, and the bottom portion comprises a folded portion of the single piece of material.

8. The package of claim 1, further comprising one or more second apertures through the front or rear portion to facilitate hanging of the package on a peg or hook.

9. The package of claim 1, further comprising one or more second apertures in a material attached to the front or rear portion to facilitate hanging of the package on a peg or hook.

10. The package of claim 1, further comprising an anti-theft device embedded within the three-dimensional structure.

11. The package of claim 1, wherein the package comprises sufficient structural integrity to hold a power tool comprising a motor disposed in the non-grip portion when the package is free standing in an upright manner.

12. The package of claim 11, wherein the power tool comprises a power tool selected from the group consisting of a drill, a hammer drill, an impact wrench, an electrically powered tool, and an air powered tool.

13. The package of claim 1, wherein the package is configured to display the tool in an orientation of use of the hand tool when the package is free standing on the bottom portion of the package.

14. A method of creating a first package to contain and display a tool, the method comprising:
cutting a paper-based portion into a pre-defined pattern, the pre-defined pattern comprising one or more slits and tabs to assist in maintaining a folded shape in accordance with the predefined pattern;
folding the paper-based portion into a configuration for encompassing the tool and to create at least a rear portion, a front portion connected to the rear portion, and a bottom portion connected to both the front and rear portion of the package, the bottom portion representing a flat surface between the front portion and the rear portion, the rear portion substantially covering an entire rear facing side of the hand tool; and
attaching a plastic-based portion to the paper-based portion to substantially cover an aperture of the pre-defined pattern while leaving a portion of the aperture to allow exposure of a grip portion of the hand tool;
wherein the first package substantially encompasses all portions of the hand tool except the grip portion; and
wherein the first package can freely stand on the bottom portion while containing the hand tool.

15. The method of claim 14, wherein the paper-based portion comprises corrugated cardboard and wherein the plastic-based portion is at least partially embedded within the corrugated cardboard around a perimeter of the plastic-based portion.

16. The method of claim 14, wherein attaching the plastic-based portion comprises attaching the plastic-based portion using an adhesive means.

17. The method of claim 14, wherein the plastic-based portion comprises a transparent material permitting at least a portion of the non-grip portion to be viewed through the transparent material.

18. The method of claim 14, wherein the first package can freely stand on the bottom portion of the first package while containing the tool and can be stacked on top of a second package of substantially similar dimensions as the resulting first package.

19. A package for displaying a tool, the tool comprising a grip portion and a non-grip portion, package comprising:
a paper-based portion, the paper based portion comprising:
a front portion, a rear portion and a bottom portion connected to both the front and rear portion;
at least one aperture conforming to at least a section of a perimeter of the non-grip portion of the tool;
one or more slits and corresponding tabs, the one or more slits and tabs to assist in maintaining a pre-defined folded shape of the paper-based portion, the pre-defined folded shape configured to encompass the hand tool;
a front portion comprising a surface area smaller than the rear portion; and
a bottom portion created by folding the paper-based portion, the bottom portion configured to allow the package containing the hand tool to stand freely; and
a plastic-based portion attached to the paper-based portion using an adhesive means and substantially covering the non-grip portion of the hand tool,
wherein the paper-based portion and plastic-based portion together substantially enclose the entire non-grip portion.

20. The package of claim 19, wherein the package is configured to display the tool in an orientation of use of the hand tool when the package is free standing on the bottom portion of the package.
